(19) United States
(12) Patent Application Publication
(10) Pub. No.: US 2004/0148109 A1
(43) Pub. Date: Jul. 29, 2004

(54) Method and apparatus for prediction of cardiac dysfunction

(76) Inventor: Russell John Fischer, Bernardsville, NJ (US)

Correspondence Address: Russell Fischer, 17 Woodland Rd., Bernardsville, NJ, 07924, US

(21) Appl. No.: 10/757,854

(22) Filed: Jan. 15, 2004

Related U.S. Application Data
(60) Provisional application No. 60/440,237, filed on Jan. 16, 2003.

(51) Int. Cl. G06F 19/00

(52) U.S. Cl. 702/32

(57) ABSTRACT

A method and apparatus for predicting cardiac dysfunction simultaneously assesses the modulation of the rate of atrial depolarization and the modulation of the rate of ventricular depolarization to monitor the interaction of the sino-atrial and atrio-ventricular pacemakers of the heart. The atrial and ventricular rate signals are formed from fiducial markers in the electrocardiogram or intracardiac electrogram corresponding to atrial and ventricular depolarization. The rate signals are characterized with a measure of their modulation, and are then compared to predict episodes of cardiac dysfunction.

### CROSS-REFERENCE TO RELATED APPLICATIONS

This application claims the benefit of U.S. Provisional Application No. 60/440,237 filed Jan. 16, 2003 by the present inventor.

### FEDERALLY SPONSORED RESEARCH

Not Applicable

### SEQUENCE LISTING OR PROGRAM

Not Applicable

### FIELD OF THE INVENTION

The present invention relates to a method and apparatus to predict cardiac dysfunction using the measurement and comparison of an atrial rate signal and a ventricular rate signal from the heart.

### BACKGROUND OF THE INVENTION

The oscillatory properties of the heart are often studied to understand dysfunctions of normal rhythmic behavior such as arrhythmia and fibrillation. One fundamental oscillatory property is the heart rate. Heart rate was traditionally thought to be regulated according to the principle of homeostasis, the principle that physiologic systems operate to reduce variability and achieve an equilibrium-like state. According to this view, heart rate would tend toward a steady level that met the demands of the body. Clinicians, in fact, traditionally described the normal heartbeat as a “regular or normal sinus rhythm.” Modern research has revealed that a normal heart does not beat at a constant rate, however. The origin of the heartbeat is electrical in nature, generated by the sino-atrial (SA) node pacemaker in the heart with a rate modulated by continuously varying neural signals from the sympathetic and parasympathetic nervous systems. The resulting heart rate at any point in time is largely the net effect of these two systems; as a consequence, normal heart rate varies even when the body is at rest.

The beat-to-beat modulation of heart rate that occurs around the mean heart rate is known as heart rate variability (HRV), and the measurement of HRV has proven to be valuable in many clinical situations. HRV analysis typically begins with the acquisition of a continuous heart rate signal. This can be derived from the electrocardiogram (ECG) either by calculating the duration of the interbeat interval (units of time) from one beat to the next or by calculating the reciprocal of the interbeat interval (heart beats per unit of time) from one beat to the next. U.S. Pat. No. 5,201,321 by Fulton, issued Apr. 13, 1993, entitled “Method and Apparatus for Diagnosing Vulnerability to Lethal Cardiac Arrhythmias” teaches a method and apparatus for receiving heartbeat signals and then calculating the beat-to-beat time intervals.

The most pronounced feature in the ECG is called the R wave. The R wave corresponds to ventricular depolarization, and because it is typically the most pronounced feature in the ECG it is easily detected and used as the basis of a rate measurement. Similar information could also be obtained from the intracardiac electrogram, the signal measured by implanted cardiac electrodes. In the remainder of this specification, we will use the term “ECG” to denote both the externally-measured signal (electrocardiogram) or the internally-measured signal (intracardiac electrogram).

It is important to note that heart rate variability analysis requires a measure of the changes in heart rate with time. Many therapeutic and diagnostic techniques utilize a static measure of heart rate that is either the average of the heart rate over some time period, or simply the inverse of a single beat-to-beat interval. These static measures of heart rate contain no information about the dynamic changes in heart rate over time, however. Information about these dynamic changes is valuable for it provides insight into the physiological systems that influence the heart and this is the motivation for HRV analysis. HRV can be characterized in a variety of ways. One example is a common HRV measure called SDNN (standard deviation of normal-to-normal heartbeat intervals), a statistical measure of the dispersion of the fluctuations of heart rate around the mean. HRV is often characterized using more advanced techniques such as frequency domain analysis or nonlinear signal analysis.

Conventional HRV analysis provides insight into extrinsic influences on the heart rate such as the autonomic nervous system and respiration. By utilizing a heart rate signal derived solely from the timing of ventricular depolarization however, HRV analysis treats the heart as if it was a single oscillator. Conventional HRV analysis does not provide insight into the intrinsic oscillatory phenomena of the heart—the interaction between the primary and secondary pacemakers. To better describe this interaction, a brief description of the electrical conduction system of the heart is useful. The electrical depolarization that triggers the heartbeat originates in the SA node, the primary pacemaker of the heart. It then spreads through the atria, stimulating them to contract. This yields a P wave on the ECG. The depolarization then passes through the atrio-ventricular (AV) node, where its conduction speed is reduced to ensure that ventricular contraction does not begin before atrial contraction has ended. On the ECG, this corresponds to a brief pause following the P wave. The depolarization then proceeds rapidly through the bundle of His, the left and right branches and the Purkinje network, stimulating the ventricles to contract. This yields a QRS complex on the ECG trace. The peak of the QRS complex is called the R wave.

In this description of electrical conduction we used the classical physiological interpretation of the behavior of the AV node, which assumes that the AV node acts as a passive conduit to the electrical impulse. Recent research ascribes a more active role to the AV node. It is thought to act as a secondary autonomous pacemaker, bi-directionally coupled to the SA node pacemaker. In this view, the electrical conduction system of the heart can be described as a system of two autonomous oscillators, one at the SA node, and another at the AV node. Cardiac models that treat the electrical conduction system of the heart as a system of two oscillators have been used to create realistic reproductions of the electrical behavior of the heart and pathologies such as Wenckebach rhythms, AV blocks, sinus arrest, and atrial bigeminy.

One shortcoming of the standard measurement of HRV then is that it does not consider independent measures of the atrial and ventricular depolarization rate. Standard HRV analysis considers only one timing event for each cardiac cycle, implicitly treating the heart as a single oscillator system, and providing no information about relative changes in timing between the atria and ventricles. Monitoring the relative timing behavior may provide a useful way to foretell cardiac dysfunction. For example, for one type of cardiac dysfunction called atrial fibrillation, it is known that the normal interaction between SA and AV pacemakers is altered such that the ventricular rate is no longer under the physiological influence of the SA node. Comparing the depolarization behavior of the atria and ventricles provides the basis of a technique to foretell such cardiac events and provide an opportunity for medical intervention before the dysfunction occurs.

This invention discloses a new measurement method and apparatus that captures timing information for both atrial and ventricular depolarization during each cardiac cycle. By acquiring timing information for both depolarizations, it is possible to study the modulation of the depolarization rate of the associated SA and AV node pacemakers to detect changes in their interaction. These changes can provide early warning of impending cardiac dysfunction before the normal electrical depolarization activity of the heart is altered by cardiac dysfunction. When cardiac dysfunction such as fibrillation or arrhythmia does occur, the course of normal electrical depolarization activity of the heart can be dramatically altered, and this will often be evident in the timing of the SA and AV pacemaker depolarization and/or the morphology of the ECG. Many techniques have been proposed in the prior art to identify and discriminate types of cardiac dysfunction based upon the consequent changes in pacemaker timing or the ECG while dysfunction is occurring, as described below.

U.S. Pat. No. 6,490,479 by Bock, discloses a method and apparatus to determine whether atrial fibrillation is occurring based on R-R interval timing and the presence/absence of the P wave in the ECG.

U.S. Pat. No. 5,788,645 by Swanson et al, discloses a method and apparatus for tachycardia detection. The technique uses binning of atrial, ventricular and atrial-ventricular time interval values to discriminate between abnormal rhythms and normal sinus rhythm.

U.S. Pat. No. 5,311,874 by Baumann et al, discloses a method for discriminating between different types of tachycardias. In this method, an event in a cardiac biopotential signal is compared to a corresponding event in a normal baseline signal by using fiducial markers in the signals to align the features prior to mathematical comparison.

In U.S. Pat. No. 5,193,535 by Bardy, et al, a method and apparatus is disclosed to distinguish ventricular tachycardia from ventricular fibrillation. During an episode of ventricular tachycardia or ventricular fibrillation, the wavefronts of electrical depolarization in the ventricle will have directions of propagation which differ from those seen in normal sinus rhythm. The inventive matter described in this patent uses a pair of electrodes to detect fiducial markers corresponding to these wavefronts, and provides means for characterizing the variability of the time interval between these markers to distinguish tachycardia from fibrillation.

In U.S. Pat. No. 5,978,700 by Nigam, an apparatus is disclosed to detect the presence of ventricular tachycardia. The apparatus uses an atrial sensor and a ventricular sensor to calculate R-R intervals and P-P intervals. These intervals or averages of these intervals are then compared to thresholds or to previous values to detect the presence of ventricular tachycardia.

In U.S. Pat. No. 4,860,749 by Lehmann, a method for distinguishing ventricular tachycardia from a sinus or other kind of supraventricular tachycardia is described, in which the R-R and P-P interval as well as the P-R interval are measured. If the R-R interval is within a predetermined range and is shorter than the P-P interval, then the condition is readily classified as ventricular tachycardia. If the atrial and the ventricular rate are approximately the same as a consequence of 1:1 A-V conduction or retrograde conduction, then the measured A-V interval is subjected to a comparison with a predetermined value and the classification criterion is obtained from the outcome of the comparison.

In U.S. Pat. No. 5,325,856 by Nitzsche et al., a method for distinguishing between ventricular and supraventricular tachycardias is disclosed, which is based on a comparison of the divergence over time in the P-R and R-R values with two predetermined threshold values at the onset of the tachycardia.

The inventive matter disclosed herein differs from these techniques in that it is intended to foretell episodes of cardiac dysfunction, not to discriminate between different forms of cardiac dysfunction while they are occurring. Furthermore, these prior art approaches utilize static estimates of atrial or ventricular rate based upon either an average heart rate over a time period or single beat-to-beat intervals. The inventive matter disclosed herein differs from these techniques in that it utilizes analysis of atrial and ventricular rate modulation over time. The rate modulations over time are then characterized and compared to reveal changes in the interaction between atrial and ventricular depolarization behavior and foretell dysfunction. The inventive matter disclosed herein teaches a method and apparatus that can be used to predict cardiac dysfunction before it occurs and affords the possibility of early intervention to stabilize the heart and prevent the onset of dysfunction.

Several methods and devices have been proposed to predict or forecast cardiac dysfunction. U.S. Pat. No. 6,035,233 by Schroeppel, et al., discloses a method and apparatus to forecast a cardiac event with a measurement of heart rate variability. To forecast a cardiac event, the measurement of HRV is compared to previously stored HRV zones that define normal and abnormal heart rate variability.

U.S. Pat. No. 5,201,321 by Fulton, discloses a method and apparatus to determine an indication of the likelihood of heart failure by measuring a heart rate variability signal and analyzing the signal to determine a mathematical quantity known as the chaotic dimension. The chaotic dimension is then provided as a measure of the condition of the heart.

U.S. Pat. No. 5,842,997 by Verrier, et al., discloses a method and apparatus to assess cardiac vulnerability by characterizing heart rate variability and beat-to-beat alternation in the morphology of the T wave.

U.S. Pat. No. 5,117,834 by Kroll, et al., discloses a method and apparatus by which pulses of electromagnetic energy are injected into a patient and the changes in the patient's electrocardiographic signals caused by the injection are recorded A number of the aforementioned methods and devices utilize measurements of heart rate variability to characterize changes in hear rate over time, however the HRV measurements are based upon a single timing event per cardiac cycle (ventricular depolarization). The inventive matter disclosed herein utilizes two timing events per cardiac cycle to derive two rate signals, one associated with atrial depolarization, another associated with ventricular depolarization. The rate modulation of the two signals is then compared to forecast a cardiac event or dysfunction.

### SUMMARY OF THE INVENTION

The principal object of the present invention is to provide a method and apparatus to predict cardiac dysfunction.

Another object of the present invention is to enable improved accuracy in the prediction of cardiac dysfunction by comparing the modulation of the rate of atrial depolarization and the modulation of the rate of ventricular depolarization.

Another object of the present invention is to monitor the condition of the heart by comparing the modulation of the rate of atrial depolarization and the modulation of the rate of ventricular depolarization.

### BRIEF DESCRIPTIONS OF THE DRAWINGS

FIG. 1 is a schematic diagram of the heart and a typical ECG plot, showing the origin of the features in the ECG.

FIG. 2 is a high-level block diagram illustrating the signal acquisition and signal pre-processing aspects of the present invention.

In FIG. 3A, FIG. 3B and FIG. 3C, high-level block diagrams illustrate the procedure by which the times of atrial and ventricular depolarization are identified, used to form time series containing the atrial and ventricular rate data, and the procedure by which the atrial and ventricular rate data are compared.

In FIG. 4A and FIG. 4B, power spectral density plots of the atrial and ventricular rate signals are shown for a patient approximately 45 minutes before an episode of atrial fibrillation (FIG. 4A) and immediately preceding an episode of atrial fibrillation (FIG. 4B).

FIG. 5A is a high-level block diagram of the apparatus of the invention.

FIG. 5B is a detailed block diagram of ECG detector and pre-processor 502.

### DETAILED DESCRIPTION OF THE PREFERRED EMBODIMENT

The preferred embodiment of the invention is now described with reference to the figures where like reference numbers indicate like elements. Also in the figures, the left most digit of each reference number corresponds to the figure in which the reference number is first used.

Those skilled in the art will recognize that the present invention may be used as part of an implanted device, or as part of a device that is not implantable. In either case, the device must be able to sense or record the cardiac waveform in order to measure the time intervals between successive atrial and ventricular depolarizations. Measurement of these intervals may be done remotely from the heart, for example with electrodes placed on the patient, or within the heart itself. In order to obtain the time intervals between successive depolarizations, signals from the heart communicate from electrodes to the cardiac monitoring device. An embodiment of the present invention will now be explained with reference to measurements made from an ECG, which utilizes skin surface electrodes. An alternate embodiment of the present invention would utilize implanted electrodes to measure the time intervals between successive atrial and ventricular depolarizations in an analogous manner.

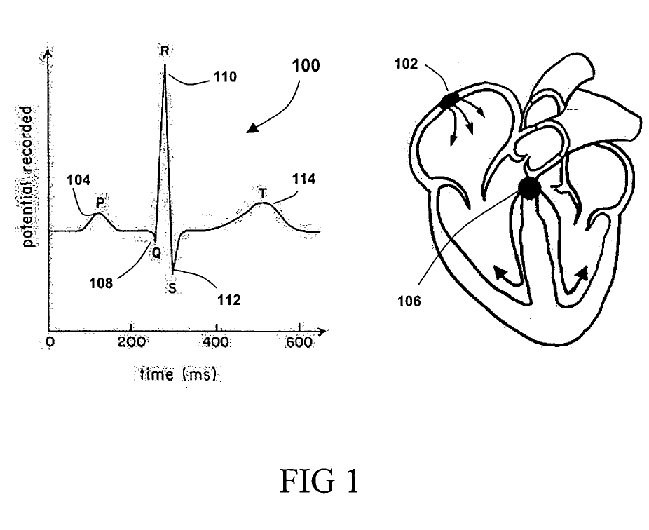

FIG. 1 shows a representative human surface ECG 100 and a simplified illustration of the heart to illustrate cardiac electrical conduction and the resulting ECG. The electrical depolarization that triggers the heartbeat originates in the SA node 102, the primary pacemaker of the heart. It then spreads through the atria, stimulating them to contract. This yields a deflection 104 on the ECG known as the “P-wave”. The impulse then passes through the AV node 106, where its conduction speed is reduced to ensure that ventricular contraction does not begin before atrial contraction has ended. On the ECG, this corresponds to a brief pause following the P wave. Deflections 108, 110 and 112 are known as the “Q-wave,” “R-wave,” and “S-wave,” respectively, and result from excitation (depolarization) of the ventricles. Deflection 114 is known as the “T-wave” and is due to recovery (repolarization) of the ventricles. One cycle (i.e., cardiac cycle or heartbeat) of the ECG from the apex of a first R-wave to the apex of the next R-wave is known as the R-R or interbeat interval. Heart rate variability (HRV) refers to the modulation of heart rate expressed as either heart beats per unit of time or the duration of the interbeat interval from one beat to the e

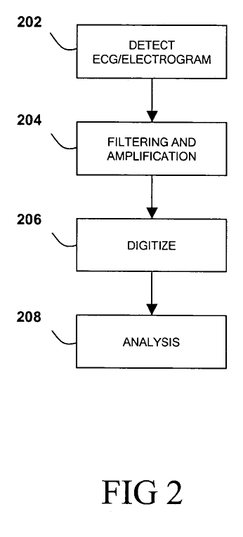

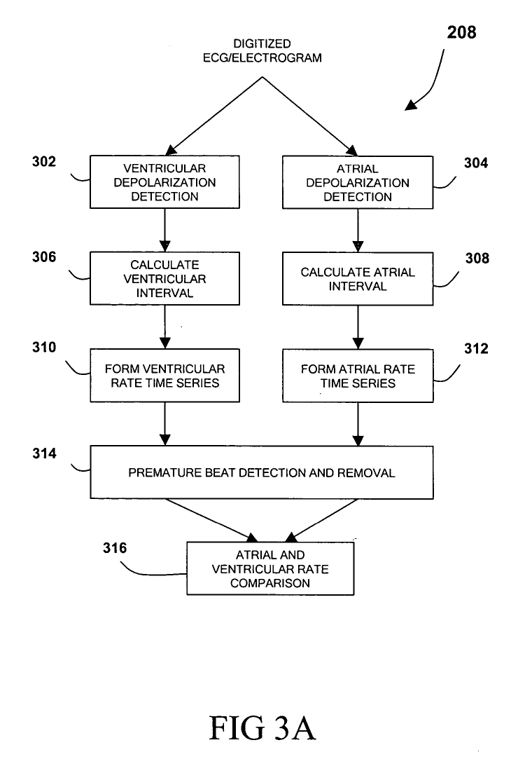

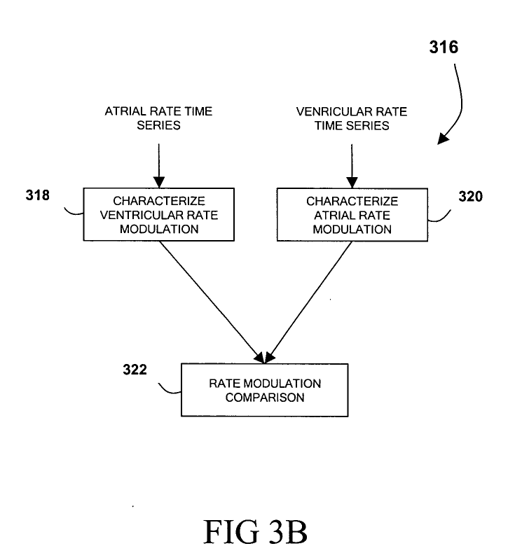

Referring to FIG. 2, an ECG or electrogram signal containing a plurality of heartbeats is sensed from a patient in real time at step 202. At step 204, the signal is processed to prepare it for digital sampling. This processing could include high-pass filtering to remove the DC component of the signal, amplification of the signal, and low-pass filtering to limit the signal bandwidth before digital sampling at step 206. Finally, the digitized ECG or electrogram data is processed or analyzed at step 208.

This invention is concerned with the detection of atrial and ventricular depolarization and the rate at which these depolarizations occur. For a skin surface ECG, the peaks of the P wave and R wave would normally be used to mark the time of atrial and ventricular depolarization, respectively. However, other markers for the time of atrial and ventricular depolarization may be used without departing from the spirit and scope of the invention as defined in the claims. The atrial and ventricular depolarizations could also be detected with implanted electrodes. In this case the intervals A-A and V-V would be measured (A-A interval is the time between successive atrial depolarizations as measured from within the atrium; V-V interval is the time between successive ventricular depolarizations as measured from within the ventricle). The timing intervals usually are measured in units of time or in terms of the number of samples between beats. The particular method or apparatus used to record the beat-to-beat intervals is not critical as long as the intervals are accurately obtained.

The analysis of the ECG/electrogram signals at step 208 is described in detail with reference to FIG. 3A. At step 302, the apex of the waveform associated with ventricular depolarization is detected in the signal data for each of the plurality of beats by finding the peak amplitudes in the digitized signal. For an ECG, this waveform is the R-wave, for an intracardiac electrogram, this is the V-wave. At step 304, the apex of the waveform associated with atrial depolarization is detected in the signal data for each of the plurality of beats by finding the peak amplitudes in the digitized signal for sub-segments of the data located relative to each ventricular depolarization waveform. At step 306, the time intervals between successive ventricular depolarizations are computed. At step 308, the time intervals between successive atrial depolarizations are computed.

At step 310, a time series of ventricular rate data (V.sub.t), whose points have equal time spacing and whose values are the ventricular depolarization time intervals present at that time or the inverse of the time interval (the rate), is formed along the time line. At step 312, a time series of atrial rate data (A.sub.t), whose points have equal time spacing and whose values are the atrial depolarization time intervals present at that time or the inverse of the time interval (the rate), is formed along the time line. Premature beats are then removed at step 314 by comparing the atrial and ventricular depolarization time intervals with fixed criteria. When a premature beat is detected, the corresponding atrial and ventricular depolarization time intervals are removed. The time series of atrial and ventricular rate data is compared in step 316.

Atrial and ventricular comparison step 316 is shown in greater detail in FIG. 3B. At step 318, the rate modulation of the ventricular rate data is characterized. At step 320, the rate modulation of the atrial rate variability is characterized. The characterization of the atrial and ventricular rate modulation can be performed with a variety of computational and statistical algorithms, known to those of ordinary skill in the art. The characterization may be statistical in nature, including any combination of at least one of a measure of central tendency or a measure of dispersion such as the mean, MAD (mean absolute deviation), median, mode (most commonly occurring inter-depolarization time interval), amplitude of mode (percentage that mode occurs), variation range (difference between highest and lowest inter-depolarization time interval), PNN50 (percentage of inter-depolarization time interval s having a duration longer than 50 ms), standard deviation, range, and variance. The characterization may be spectral in nature, including some measure of the frequency or phase content of the rate data such as the power spectral density, time-frequency analysis or the wavelet transform. The characterization may be parametric in nature, whereby the rate data is fit to a predefined model (linear or nonlinear), and the fitting parameters used to characterize the data. Finally, the ventricular and atrial rate modulation is compared in step 322. The measures of rate modulation derived in steps 318 and 320 may be displayed for visual comparison by a human user, or may be compared mathematically.

The functional block diagram shown in FIG. 3C illustrates an embodiment of the analysis procedure illustrated in FIG. 3A and FIG. 3B with the exception that the ventricular rate modulation characterization element step 318 is implemented using power spectral density analysis in step 324 and the atrial rate modulation characterization element step 320 is implemented using power spectral density analysis in step 326. The atrial and ventricular rate modulation spectra are then compared in step 328. By using power spectral density analysis, the frequency content of a signal may be revealed and used as the basis for comparison of the two rate signals. An example of this is illustrated in FIG. 4A, which shows a power spectral density plot 402 for the atrial rate signal and a power spectral density plot 404 for the ventricular rate signal. These power spectral density plots were derived from a segment of ECG data for a patient approximately 45 minutes before an episode of atrial fibrillation. FIG. 4B shows corresponding atrial 406 and ventricular 408 power spectral density plots for the same patient immediately preceding an episode of atrial fibrillation. It can be seen that the atrial and ventricular power spectral density plots appear more similar at the onset of atrial fibrillation. The power spectral density plots for the atrial and ventricular rate modulation signals that are produced in this embodiment can then be displayed for visual comparison by a human user, or be computationally compared by a variety of techniques known to those with ordinary skill in the art.

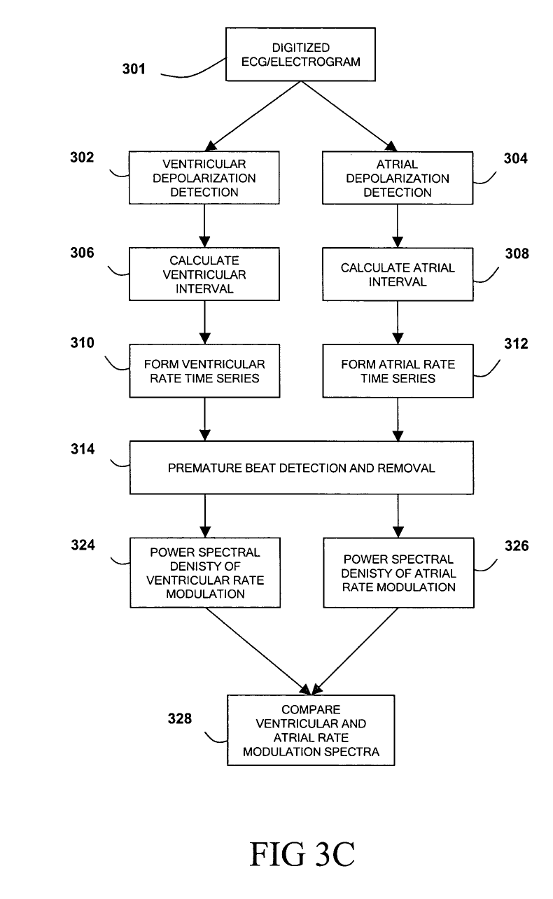

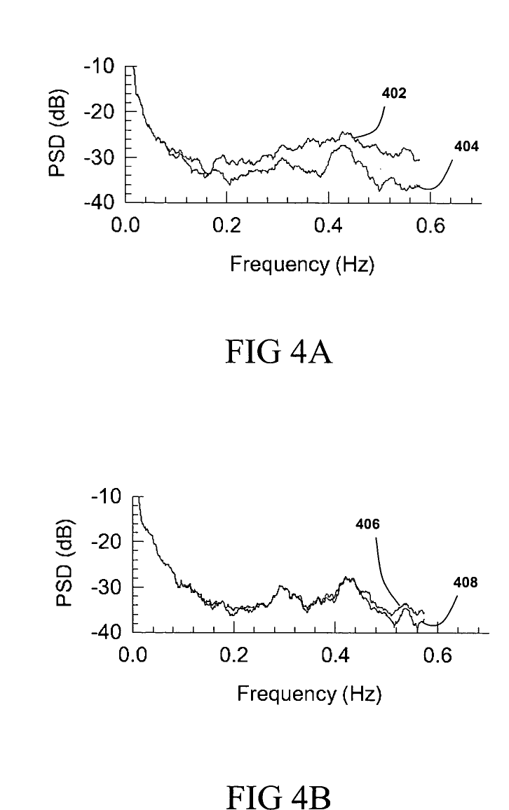

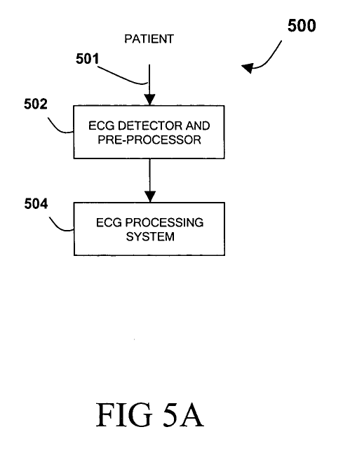

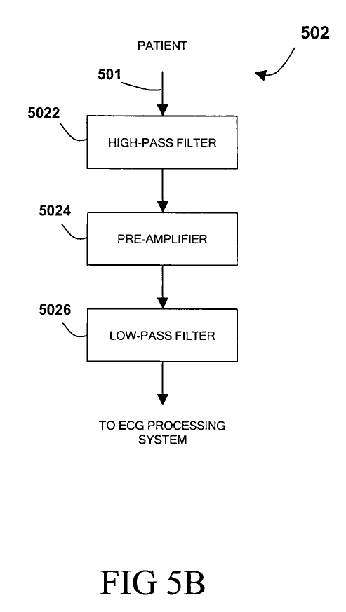

The preferred embodiment of the apparatus of the invention is described with reference to FIGS. 2, 3 and 5. Steps 202-204 of the method may be performed using a conventional ECG machine or may be performed using dedicated hardware. Similarly, steps 206-208 may be performed on a general purpose computer or may performed by dedicated hardware. In the preferred embodiment, the invention is carried out on a heart monitoring unit (HMU) 500, shown in FIG. 5A. HMU 500 includes ECG sensing leads 501, an ECG detector and pre-processor 502 and an ECG processing system 504. ECG detector and pre-processor 502, shown in greater detail in FIG. 5B, includes a high-pass filter 5022, a pre-amplifier 5024, and a low-pass filter 5026. ECG sensing leads (i.e., electrodes) 501 provide a signal from a patient directly to high-pass filter 5022. In an alternate embodiment, ECG detector and pre-processor 502 is a conventional ECG monitoring machine. ECG processing system 504 performs steps 302-328 of the method on either a general-purpose computer or dedicated hardware. The invention, in terms of how it is embodied, is not limited to the preferred exemplary embodiment described above. On the contrary, a number of variants that make use of the provisions shown, even in a different kind of embodiment, are conceivable.

I claim:

1. A method comprising the steps of:
sensing a first electrical signal from a patient's heart indicative of the rate of depolarization of a chamber or chambers of said patient's heart;
sensing a second electrical signal from said patient's heart indicative of the rate of depolarization of a chamber or chambers of said patient's heart;
assessing said first electrical signal to characterize changes in the rate of depolarization of said chamber or chambers of said patient's heart over a period of time and issuing a first signal indicative of the magnitude of the rate modulation;
assessing said second electrical signal to characterize changes in the rate of depolarization of said chamber or chambers of said patient's heart over a period of time and issuing a second signal indicative of the magnitude of the rate modulation;
analyzing said first signal indicative of the magnitude of the rate modulation and said second signal indicative of the magnitude of the rate modulation to assess the condition of the heart.

2. A method comprising the steps of:
sensing atrial depolarizations of the heart;
forming an atrial rate signal corresponding to the rate of said atrial depolarizations over time;
sensing ventricular depolarizations of the heart;
forming a ventricular rate signal corresponding to the rate of said ventricular depolarizations over time;
comparing said atrial rate signal to said ventricular rate signal.

3. The method of claim 2 wherein sensing atrial depolarizations comprises:
receiving an ECG signal;
detecting a sequence of P-waves in said ECG signal;

4. The method of claim 2 wherein sensing atrial depolarizations comprises:
receiving an intracardiac electrogram signal;
detecting a sequence of atrial depolariztions in said intracardiac electrogram signal;

5. The method of claim 2 wherein forming an atrial rate signal comprises:
calculating a time interval between successive atrial depolarizations to determine a magnitude of the atrial depolarization period;
forming a time series with the magnitudes of said atrial depolarization periods.

6. The method of claim 2 wherein forming an atrial rate signal comprises:
calculating the inverse of a time interval between successive atrial depolarizations to determine a magnitude of the atrial depolarization rate;
forming a time series with the magnitudes of said atrial depolarization rates.

7. The method of claim 2 wherein sensing ventricular depolarizations comprises:
receiving an ECG signal;
detecting a sequence of R-waves in said ECG signal;

8. The method of claim 2 wherein sensing ventricular depolarizations comprises:
receiving an intracardiac electrogram signal;
detecting a sequence of ventricular depolariztions in said intracardiac electrogram signal;

9. The method of claim 2 wherein forming a ventricular rate signal comprises:
calculating a time interval between successive ventricular depolarizations to determine a magnitude of the ventricular depolarization period;
forming a time series with the magnitudes of said ventricular depolarization periods.

10. The method of claim 2 wherein forming a ventricular rate signal comprises:
calculating the inverse of a time interval between successive ventricular depolarizations to determine a magnitude of the ventricular depolarization rate;
forming a time series with the magnitudes of said ventricular depolarization rates.

11. The method of claim 2 wherein said step of comparing an atrial rate signal to a ventricular rate signal comprises:
calculating a measure of atrial rate modulation of said atrial rate signal;
calculating a measure of ventricular rate modulation of said ventricular rate signal;
calculating a measure of the similarity of said measure of atrial rate modulation and said measure of ventricular rate modulation.

12. The method of claim 2 wherein said step of comparing an atrial rate signal to a ventricular rate signal comprises:
calculating a measure of atrial rate modulation of said atrial rate signal;
calculating a measure of ventricular rate modulation of said ventricular rate signal;
displaying said measure of atrial rate modulation and said measure of ventricular rate modulation to a human user for visual comparison.

13. An apparatus comprising:
first means for sensing electrical signals from a patient's heart indicative of the depolarization of a chamber or chambers of said patient's heart;
second means for sensing electrical signals from said patient's heart indicative of the depolarization of said chamber or chambers of said patient's heart;
first rate modulation assessment means, coupled to said first sensing means for characterizing changes in the rate of depolarization of said chamber or chambers of said patient's heart over a period of time and issuing a signal indicative of the magnitude of said rate modulation;
second rate modulation assessment means, coupled to said second sensing means for characterizing changes in the rate of depolarization of said chamber or chambers of said patient's heart over a period of time and issuing a signal indicative of the magnitude of said rate modulation;
means for analyzing said magnitude of atrial rate modulation and said magnitude of ventricular rate modulation to assess the condition of the heart.
